(19) United States
(12) Patent Application Publication
(10) Pub. No.: US 2026/0061344 A1
(43) Pub. Date: Mar. 5, 2026

(54) MEDIA VESSEL FOR LIQUID TREATMENT

(71) Applicant: YARDNEY WATER MANAGEMENT SYSTEMS INC., Riverside, CA (US)

(72) Inventors: Joseph GIFFORD, Marlborough, MA (US); Chris PHILLIPS, Riverside, CA (US); Abishek ARUMUGAM NAVUKKARASAN, Medford, MA (US)

(73) Assignee: YARDNEY WATER MANAGEMENT SYSTEMS INC., Riverside, CA (US)

(21) Appl. No.: 19/384,230

(22) Filed: Nov. 10, 2025

Related U.S. Application Data
(60) Provisional application No. 63/818,344, filed on Jun. 5, 2025.

(51) Int. Cl. B01D 24/38; B01D 15/22; B01D 24/14

(52) U.S. Cl. CPC B01D 24/38; B01D 15/22; B01D 24/14

(57) ABSTRACT

A pressurized media vessel for liquid treatment includes a fluid outlet system designed to improve performance and reduce physical height. The system features a plurality of fluid connections distributed at multiple radial positions across the bottom wall of the vessel, an arrangement that promotes uniform fluid collection and enhances treatment efficiency. In some embodiments, the fluid outlet system includes a segmented manifold. This segmentation creates a passage that allows a media outlet line to be routed in the same horizontal plane as the manifold itself. This coplanar design minimizes the overall vertical height of the vessel assembly, making it ideal for retrofitting existing facilities and for new installations where space is limited.

### CROSS-REFERENCE TO RELATED APPLICATION

This application claims priority to and the benefit of U.S. Provisional Patent Application No 63/818,344 (filed Jun. 5, 2025) which is incorporated by reference herein in its entirety.

### GENERAL DESCRIPTION

This application relates to pressurized media vessels for liquid treatment, and more particularly, to a system and method for improving flow uniformity and reducing the overall height of such vessels. This invention provides a compact, high-performance media vessel utilizing a fluid outlet system with fluid connections located at multiple radial positions across the bottom wall, and a coplanar media outlet routing strategy. These design features improve flow uniformity, reduce head loss, and minimize system height, critical for retrofits and space-constrained applications. The invention is adaptable to various vessel sizes, media types, and operational configurations, including parallel or series treatment systems.

Pressurized vessels have long been used in water treatment systems for processes such as filtration and adsorption. These vessels commonly contain granular media, such as sand, activated carbon, or ion exchange resins, that remove contaminants to improve taste, odor, or to meet health-based contaminant limits. In recent years, regulatory and public health concerns about per- and polyfluoroalkyl substances (PFAS) have accelerated the demand for large-scale, high-efficiency adsorption systems capable of removing these contaminants to parts-per-trillion levels.

To meet high flow demands, often in the millions of gallons per day, treatment facilities use large-diameter pressure vessels, typically 10 to 12 feet wide, with sidewall heights of 5 to 10 feet. This results in vessels that may exceed 16 feet in total height, which complicates installation within existing buildings and increases cost due to the need for additional structural accommodations.

Conventional vessels include an overdrain near the top for influent water distribution and an underdrain near the bottom for collecting treated effluent. Uniform flow distribution across the media bed is essential to avoid premature contaminant breakthrough and to optimize media usage. Media manufacturers typically recommend a minimum empty bed contact time (EBCT) of 10 minutes to ensure effective PFAS removal. Uneven flow, resulting from suboptimal fluid collection design, can reduce contact time and increase operating costs.

Underdrain systems are traditionally constructed using internal cones, header/lateral configurations, or external manifolds with outlet points (e.g., nozzles or septa) that penetrate the vessel bottom. In large-diameter vessels, external fluid manifolds are often favored due to ease of access and the potential to avoid confined space entry (CSE) for maintenance. However, many of these designs still suffer from suboptimal radial flow uniformity.

Computational fluid dynamics (CFD) modeling is frequently used to evaluate internal vessel hydraulics and inform design decisions regarding flow distribution and pressure loss. Even so, many existing designs fail to achieve ideal plug flow or balance the tradeoff between system height, maintenance access, and flow performance.

In typical legacy systems, both treated fluid and media may exit through the bottom of the vessel. The media outlet line is often routed above or below the fluid manifold, increasing system height and complicating service operations. Moreover, when a fluid connection is placed at the center of the vessel bottom, the media line must be shifted off-center, increasing mechanical complexity.

The present invention addresses these limitations by providing a fluid outlet system comprising multiple fluid connections located at distinct radial positions across the vessel bottom, such as the center and/or one or more concentric circular bands. These connections are coupled to a segmented fluid manifold, which allows a media outlet line to pass between segments in a plane coplanar with the fluid outlet system. This design improves radial flow uniformity, reduces pressure loss, simplifies maintenance, and minimizes the overall height of the vessel.

### SUMMARY

The embodiments disclosed herein relate to a compact, high-performance media vessel that improves flow uniformity and reduces overall system height. The invention utilizes a fluid outlet system comprising multiple fluid connections located at distinct radial positions across the bottom wall of the vessel, such as at the center and/or along one or more concentric circular bands. These connections are coupled to a segmented fluid manifold. The segmented design of the manifold allows a media outlet line to pass between the segments in a plane that is coplanar with the fluid outlet system. This innovative routing strategy significantly reduces the vertical height of the vessel assembly, which is critical for retrofits and other space-constrained applications. The strategic placement of multiple fluid connections across the vessel bottom improves radial flow uniformity, reduces head loss, and optimizes media usage by ensuring a more consistent fluid velocity throughout the media bed. The disclosed embodiments provide a more efficient and compact solution for high-flow water treatment and are adaptable to various vessel sizes, media types, and operational configurations, including systems with single or multiple vessels arranged in parallel or series.

In one embodiment, a pressurized media vessel assembly for liquid treatment is disclosed. The assembly comprising, a vessel body having a bottom wall, a fluid outlet system comprising a plurality of fluid connections located at multiple radial positions across the bottom wall of the vessel to promote uniform collection of treated liquid from the media bed.

In another embodiment, a pressurized media vessel assembly for liquid treatment is disclosed. The assembly comprising, a vessel body having a bottom wall, a segmented fluid manifold mounted on the bottom wall, where the segmented fluid manifold is configured to drain liquid from the vessel body. A media outlet line configured to transport the media from the vessel, wherein the media outlet line routed through a space between the segmented portions of the segmented fluid manifold and in a plane coplanar with the manifold to reduce overall height of the assembly.

In another embodiment, a method of treating liquid in a pressurized media vessel is disclosed. The method comprising distributing influent through a media bed inside a cylindrical vessel. Collecting treated fluid through fluid connections distributed at multiple radial locations along the bottom wall. Discharging media through a separate outlet line routed in a plane coplanar with the fluid connections, wherein the fluid connections.

### BRIEF DESCRIPTION OF THE DRAWINGS

FIG. 1 shows a prior art manifold system.

FIG. 2 shows a prior art manifold system.

FIG. 3 shows a prior art manifold system.

FIG. 4 shows the bottom of the vessel with an exemplary arrangement of the fluid and media connections.

FIG. 5 shows an exemplary bottom of the vessel with an exemplary arrangement of the fluid and media connections.

FIG. 6 shows a dual ring-shaped fluid manifold.

FIG. 7 shows the bottom for an exemplary vessel having a dual ring-shaped fluid manifold.

FIG. 8 shows an exemplary dual ring-shaped fluid manifold and the media connection line attached to the bottom of the vessel.

FIG. 9 shows an exemplary vessel with an exemplary design of the dual ring-shaped fluid manifold and the media connection line attached to the bottom of the vessel.

FIG. 10 shows a two-vessel system comprising a left and right vessel, each with fluid manifolds, and a system fluid connection and control tree.

FIG. 11 shows a computer model of fluid flow inside two similar vessels with different fluid manifold arrangements.

### DETAILED DESCRIPTION

The particulars shown herein are by way of example and for purposes of illustrative discussion of the disclosed embodiments and are presented to provide a readily understood description of the principles and conceptual aspects. In this regard, no attempt is made to show structural details in more detail than is necessary for a fundamental understanding, and the description taken together with the drawings make apparent to those skilled in the art how the disclosed devices and methods may be embodied in practice.

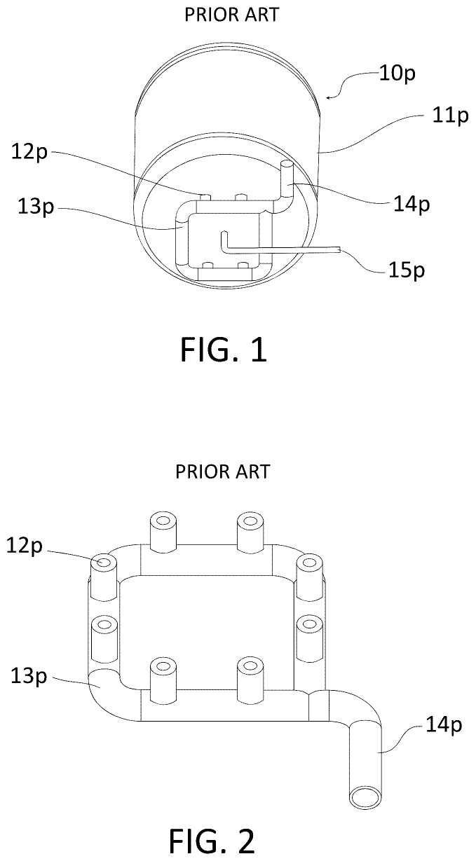

FIG. 1 shows a prior art vessel 10p with an outer wall 11p, a ring-shaped fluid manifold 13p, and eight connections 12p to the bottom of the vessel. Fluid that leaves the bottom of the vessel 10p collects in the fluid manifold 13p and exits through the common fluid connection 14p. In some cases, fluid may also enter the common fluid connection 14p, pass through the fluid manifold 13p and enter the vessel through the fluid connections 12p. Media inside the vessel may be added or removed through the media connection line 15p shown attached to the center of the vessel 10p and running horizontally below the fluid manifold 14p. In some cases, the media connection line 15p may be used for fluid passage into or out of the vessel 10p. The media connection line 15p may also run above the fluid manifold 13p.

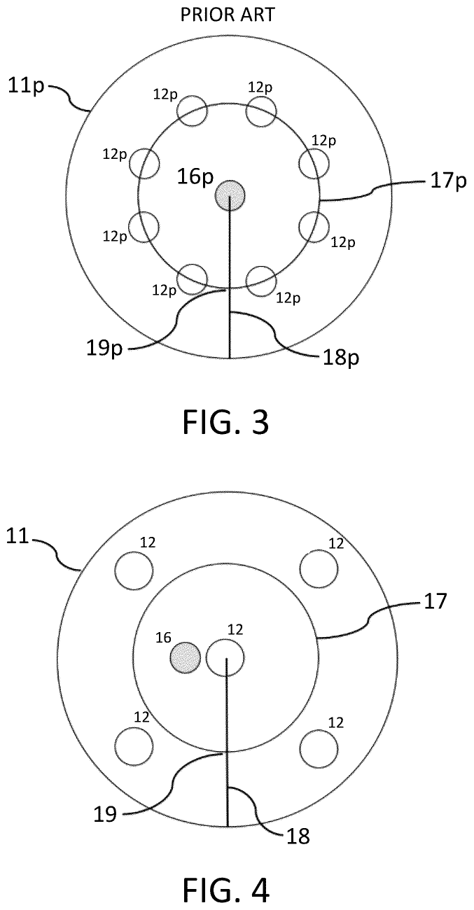

FIG. 2 shows the prior art ring-shaped fluid manifold 13p, eight fluid connections 12p, and the common fluid connection 14p with the vessel 10p removed. FIG. 3 is a drawing of the bottom of the vessel showing the points of fluid connection 12p and media connection 16p to the bottom of vessel. A circle 17p is shown concentric to the outer vessel wall 11p and drawn at the midpoint 19p of the vessel radius 18p. The eight fluid connections 12p have their midpoints approximately along this circle 17p and is attached to the bottom of the prior art vessel 10p as shown in FIG. 3.

FIG. 4 is a drawing of the bottom of the vessel with an exemplary arrangement of the fluid connections 12 and media connection 16 to the bottom of the vessel. Here, the media connection 16 is shifted off-center (i.e. offset) and one of the fluid connections 12 is shown at the center of the bottom of the vessel. Another four fluid connections 12 are shown outside of the concentric circle 17 at the radius midpoint 19. Depending on the vessel diameter, the type of media used, the flowrate of the fluid, and other factors affecting the fluid behavior, the size and number of fluid connections may change to optimize between performance, pressure loss, operating cost, and capital cost. In addition, some scenarios may require a combination of these design concepts, such as a center fluid connection along with two radial bands of fluid connections or some combination with greater than two radial bands of fluid connections. Furthermore, the fluid connections 12 may be threadedly attached, flanged, or otherwise removably mounted from the exterior of the vessel's bottom wall to facilitate inspection, maintenance, or replacement without requiring confined space entry.

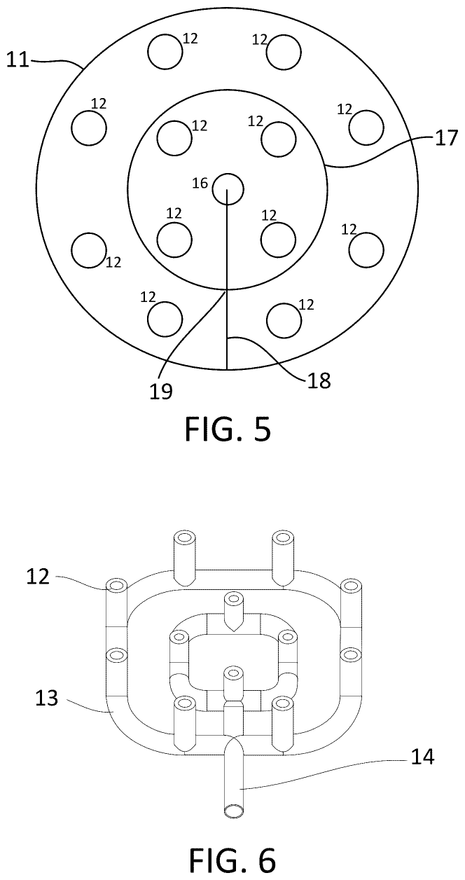

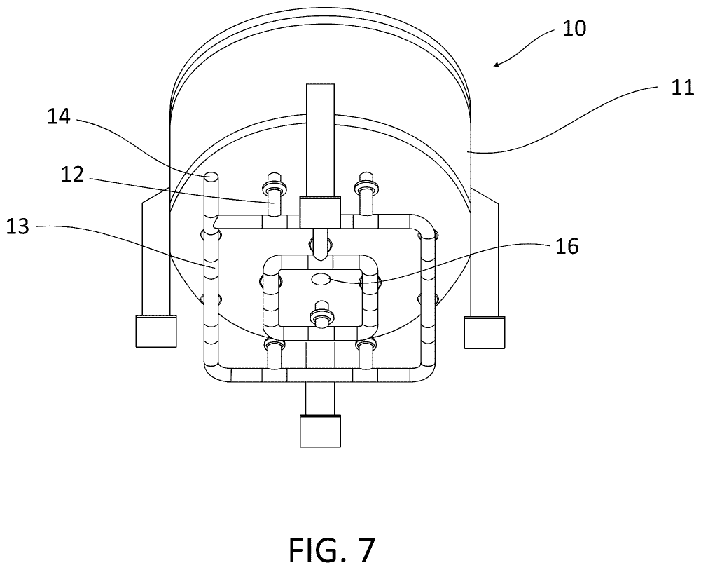

FIG. 5 is a drawing of the bottom of the vessel with an exemplary arrangement of the fluid and media connections. Shown is a total of twelve fluid connections 12, with four inside of the concentric circle 17 at radius midpoint 19, and eight between the concentric circle 17 and the outer vessel wall 11. FIG. 6 is a drawing of a dual ring-shaped fluid manifold 13 with twelve fluid connections 12 as described by FIG. 5. FIG. 7 is a drawing of the vessel 10 with a variation of the dual ring-shaped fluid manifold 13 with twelve fluid connections 12 attached to the bottom of the vessel and one common fluid connection 14. Fluid collected from all twelve connections 12 is channeled through and consolidated at the common fluid connection 14. This common fluid connection 14 serves as the main conduit for the entire manifold assembly, acting as the primary interface for connecting to external piping. While it serves as the outlet during a normal service cycle, it functions as the inlet during a reverse flow backwash or regeneration cycle. The connections of the manifold 13 may be threadedly attached, flanged, or otherwise removably mounted to different fluid connections 12 and to other manifold pipes 13.

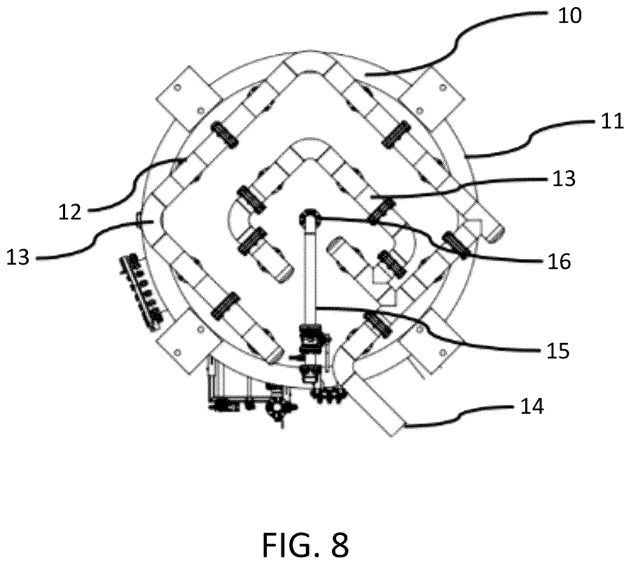

FIG. 8 is a drawing of an exemplary design of the dual ring-shaped fluid manifold 13 with twelve connections 12 and the media connection line 15 attached to the center of the bottom of the vessel 10. Here the dual ring-shaped fluid manifold does not make a complete circle so that there is a gap in the manifold 13 where the media connection line 15 can pass coplanar to the dual ring-shaped manifold 13. With the fluid manifold 13 and media connection line 15 coplanar, the overall heigh of the system can be reduced. The gap in the manifold is shown as a straight section, but it could take any form necessary to accommodate the media connection line, such as a curved cutout or other geometric shape. Furthermore, the outlet pattern need not be circular and could be arranged in other patterns, such as a rectilinear grid or a starburst pattern, to achieve the desired hydraulic performance.

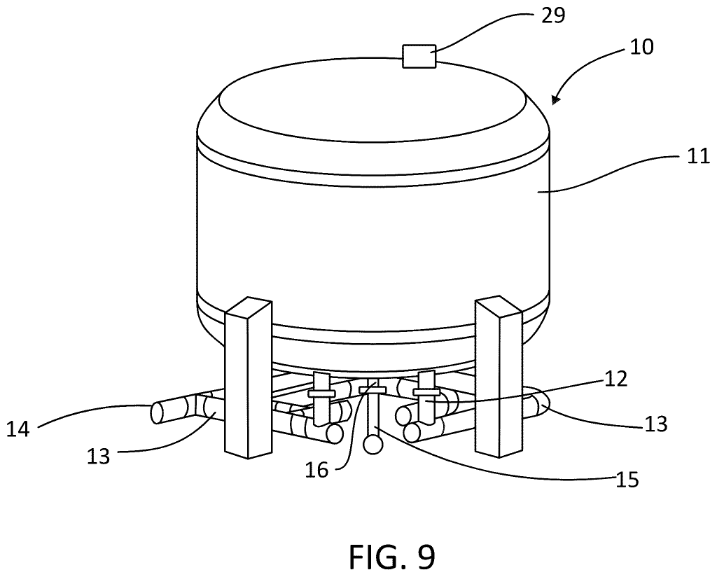

FIG. 9 is a drawing of the vessel 10 with an exemplary design of the dual ring-shaped fluid manifold 13 and the coplanar media connection line 15 attached to the bottom of the vessel 10 at the vessel center 16. In one embodiment, the vessel may include an upper manway 29.

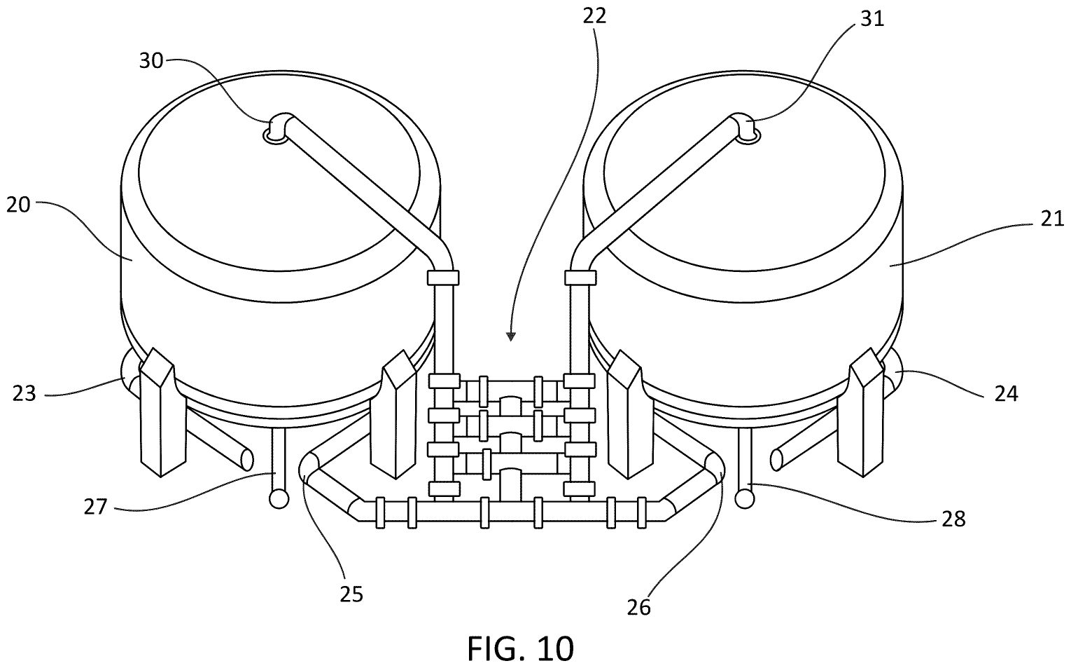

FIG. 10 is a drawing of a two-vessel system comprising a left vessel 20, a right vessel 21, a left fluid manifold 23, a right fluid manifold 24, and a system fluid connection and control tree 22. The left fluid manifold 23 collects fluid from the left vessel, which passes into the left common fluid connection 25 and flows to the system fluid connection and control tree 22. The right fluid manifold 24 collects fluid from the right vessel, which passes into the right common fluid connection 26 and flows to the system fluid connection and control tree 22. The system fluid connection and control tree 22 connects to the plant fluid supply and return lines (not shown) and can direct fluid in several different ways so that the fluid can pass down or up through the vessels. The system fluid connection and control tree 22 can also direct flow through the two vessels in series or in parallel and can operate one or both vessels simultaneously. The systems can also be assembled using a single vessel or greater than two vessels with modifications to the system fluid connection and control tree.

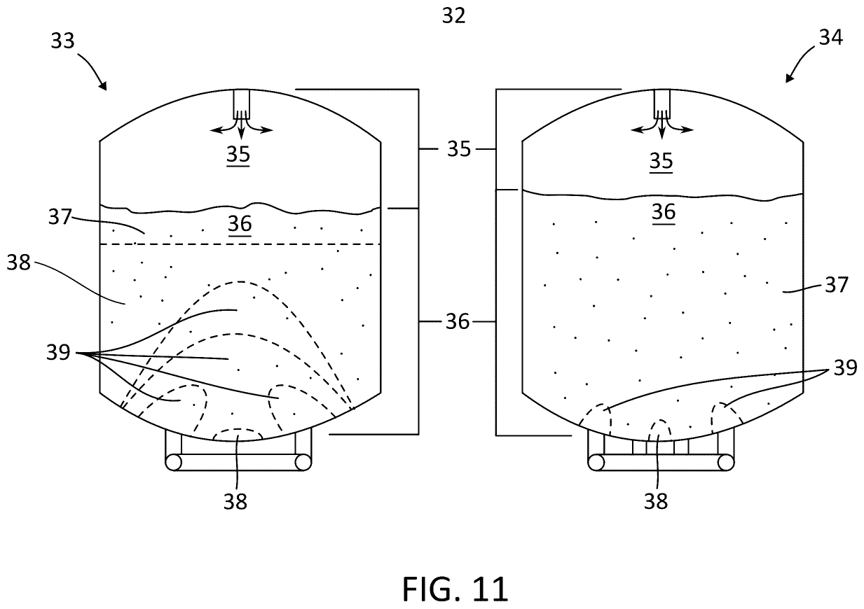

FIG. 11 shows the output of a computer model 32 of the fluid flow inside two similar vessels 33, 34 with different fluid manifold arrangements. The image on the left shows the fluid flow for a conventional vessel 33 with a fluid manifold with eight fluid connections at the midpoint of the vessel radius as shown in FIG. 3. The image on the right shows the fluid flow for a vessel 34 with a fluid manifold with twelve fluid connections placed inside and outside of the midpoint of the vessel radius as shown in FIG. 5 (e.g. eight outer connections and four inner connections). Both images show a first area at the top of the vessels which is fluid 35 above the media and a second area below the fluid 35 which is the media 36.

The flow in the left vessel 33 has a small band of fluid with a consistent fluid velocity near the top of the media bed 36. Just below that and emanating near the center of the vessel is an area of relatively high velocity 39 that accelerates as the fluid approaches the bottom of the vessel. This leaves an area of relatively low velocity 38 along the sides of the vessel and at a small region in the bottom center.

The flow in the right vessel 34 has a large area of fluid with a consistent velocity 37 across the entire width of the vessel. There are only some small areas at the very bottom of the vessel where the flow has a relatively high velocity 39 or relatively low velocity 38.

While the embodiments shown depict eight or twelve fluid connections, it is to be understood that any number of connections may be utilized depending on the specific application. The optimal number and placement may be determined through methods such as computational fluid dynamics (CFD) modeling to achieve the desired flow uniformity.

As used herein, the term “media” or “treatment media” refers to any substance or material contained within the vessel that is used to treat a fluid. This includes, without limitation, materials used for adsorption, absorption, filtration, ion exchange, chemical reaction, or other physical or chemical treatment processes.

As described above, a functional distinction between the connections is that the fluid connections 12 are configured to permit the passage of liquid while retaining the solid media within the vessel, for example by incorporating a screen, a mesh, or slotted nozzles. In contrast, the media connection 16 is typically an open, unobstructed port designed to allow for the removal of media.

As described above, media connection and media connection line may also be referred to as media outlet and media outlet line respectively.

The foregoing examples have been provided merely for the purpose of explanation and are in no way to be construed as limiting of implementations of the present invention. While aspects of the present invention have been described with reference to an exemplary embodiment, the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations disclosed herein are not intended to be limited to the particulars disclosed herein; rather, implementations of the present invention extend to all functionally equivalent structures, methods and uses, such as are within the scope of the appended claims.

What is claimed is:

1. A pressurized media vessel assembly for liquid treatment comprising:
a vessel body having a bottom wall;
a fluid outlet system comprising a plurality of fluid connections located at multiple radial positions across the bottom wall of the vessel to promote uniform collection of treated liquid from the media bed.

2. The assembly of claim 1, wherein the fluid connections include a center fluid connection substantially located at the center of the bottom wall and at least one additional group of fluid connections arranged in a circular pattern at a greater radial distance.

3. The assembly of claim 2, further comprising a media outlet line offset from the center fluid connection.

4. The assembly of claim 1, wherein the fluid connections are distributed in two or more concentric circular bands at different radial positions.

5. The assembly of claim 4, wherein the fluid outlet system comprises a common fluid connection that consolidates fluid flow from the two or more concentric circular bands.

6. The assembly of claim 5, wherein the common fluid connection is coplanar with the two or more concentric circular bands.

7. The assembly of claim 1, wherein the fluid outlet system further comprises a manifold segmented to accommodate a separately routed media outlet line.

8. The assembly of claim 7, wherein the manifold and media outlet line are positioned in a common horizontal plane.

9. The assembly of claim 1, wherein the media outlet line is routed to avoid interference with a centrally located fluid connection.

10. The assembly of claim 1, wherein the fluid connections are removably mounted from the exterior of the vessel.

11. A pressurized media vessel assembly for liquid treatment comprising:
a vessel body having a bottom wall;
a segmented fluid manifold mounted on the bottom wall, where the segmented fluid manifold is configured to drain liquid from the vessel body; and
a media outlet line configured to transport the media from the vessel, wherein the media outlet line routed through a space between the segmented portions of the segmented fluid manifold and in a plane coplanar with the manifold to reduce overall height of the assembly.

12. The assembly of claim 11, wherein the media outlet line and fluid connections operate independently to handle media discharge and treated fluid collection respectively.

13. The assembly of claim 11, further comprising a plurality of fluid connections located at multiple radial positions across the bottom wall of the vessel, configured to promote uniform collection of treated liquid from the media bed.

14. The assembly of claim 13, wherein the plurality of fluid connections includes a center fluid connection substantially at the center of the bottom wall and at least one additional group of fluid connections arranged in a circular pattern at a greater radial distance.

15. The assembly of claim 13, wherein the plurality of fluid connections is distributed in two or more concentric circular bands at different radial positions.

16. The assembly of claim 13, wherein the plurality of fluid connections is removably mounted from an exterior of the vessel.

17. A method of treating liquid in a pressurized media vessel, comprising:
distributing influent through a media bed inside a cylindrical vessel;
collecting treated fluid through fluid connections distributed at multiple radial locations along the bottom wall;
discharging media through a separate outlet line routed in a plane coplanar with the fluid connections.

18. The method of claim 17, wherein the fluid connections include both a centrally located connection and a set of peripheral connections arranged in a circular band.

19. The method of claim 17, wherein the fluid connections are arranged in two or more circular patterns at distinct radial distances and do not include a central connection.

20. The method of claim 17, wherein the fluid connections include a manifold, said manifold is segmented to accommodate the routing of the media outlet line.
